(19) United States
(12) Patent Application Publication
(10) Pub. No.: US 2021/0214124 A1
(43) Pub. Date: Jul. 15, 2021

(54) MULTI-LAYER FOOD TRAY AND METHOD OF USE

(71) Applicant: Luis Miguel Fonseca, Colleyville, TX (US)

(72) Inventor: Luis Miguel Fonseca, Colleyville, TX (US)

(21) Appl. No.: 16/743,226

(22) Filed: Jan. 15, 2020

(51) Int. Cl. B65D 25/14; B65D 1/34; B65D 81/34; A23L 5/10

(52) U.S. Cl. CPC B65D 25/14; B65D 1/34; A23V 2002/00; A23L 5/10; B65D 81/34

(57) ABSTRACT

A food tray having a bottom wall and a sidewall extending from the base, wherein the base and the sidewall form a food storage area. The food tray further includes a first liner overlaying at least a portion of the food storage area and a second liner disposed between the first liner and at least a portion of the bottom wall, the second liner covering at least a portion of the food storage area. The first liner includes a tab with an identifier thereon and the second liner includes a tab with an identifier thereon different from the identifier of the first liner.

### TECHNICAL FIELD

This disclosure relates to food trays, and in particular, to multi-layered food trays used for preparation, cooking and storage of foods.

### BACKGROUND

A food preparation tray is designed to provide a surface to prepare and/or cook food. In many instances, however, preparing and/or cooking food requires multiple trays and/or dishes. For example, when grilling, a tray is used to hold and marinate raw meat or vegetables prior to grilling. After the food has been grilled, a user must either clean the tray or use a second tray/dish in order to avoid contaminating the cooked food with the remnant raw juices from prior to cooking. This can be wasteful, create an unnecessary hassle and be generally messy for the user.

### SUMMARY

This disclosure describes methods and systems for a multi-layer food preparation tray. The multi-layer tray provides accommodations for a multi-stage food preparation process. For example, the tray includes multiple layers, or liners, which allow a user to prepare raw meat (or other foods) in the tray, remove the meat for cooking, and replace the meat in the same tray for resting, serving, and/or storing. As explained in the present disclosure, the multi-layer food tray eliminates the hassle, mess, and waste that occurs existing food preparation trays and dishes.

According to a first embodiment, there is provided a multi-layer food tray having a bottom wall and a sidewall extending from the bottom wall base to form a food storage area. The food tray also includes a first liner overlaying at least a portion of the food storage area and a second liner disposed between the first liner and at least a portion of the bottom wall, the second liner covering at least a portion of the food storage area. In some embodiments, the first liner includes a tab with an identifier thereon and the second liner includes a tab with an identifier thereon different from the identifier of the first liner.

According to another embodiment, the first and second liners correspond in shape to the shape of the food tray.

According to yet another embodiment, the identifiers of the first and second liners are colors.

According to other embodiments, the identifiers of the first and second liners are symbols.

According to yet another embodiment, the bottom wall is rectangular.

In still other embodiments, the first liner overlays the bottom wall and the sidewall.

In yet other embodiments, the second liner overlays the entire bottom wall.

According to other embodiments, the sidewall forms an opening to facilitate access to the food storage area and the second liner is sized to enclose the opening to the food storage area.

In still another embodiment, the tabs are sized and positioned to facilitate the removal of the first and second liners.

According to a second aspect, there is provided a method of using a food tray, the method including placing food on a first liner disposed within a food storage area of the food tray and preparing the food as desired while the food is on the first liner. The method further includes removing the food from the food tray and removing the first liner from the food storage area to expose a second liner in the food storage area. The method also includes removing the second liner from the food storage area to expose a bottom wall of the food storage area. The method also includes returning the cooked food, once cooked or otherwise processed, to the food storage area so as to be supported on the bottom wall. The method also includes placing the second liner on top of the cooked food.

In another embodiment, the method includes enclosing the food storage area with the second liner.

In yet another embodiment, the method includes disposing the first and second liners in a waste receptacle after use.

In still another embodiment, the method further includes disposing the food tray in a waste receptacle after use.

In yet another embodiment, the method further includes reheating the food while in the food tray after placing the second liner on top of the cooked food.

In still other embodiments, the method includes placing the food or additional food on the second liner prior to removing the second liner from the food tray.

In yet other embodiments, the method further includes differentiating between the first and second tabs based on a color coding.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is an illustration of an embodiment of a multi-layer food tray having removable liners disposed therein.

FIG. 2 is an illustration of the food tray of FIG. 1 having removable liners disposed within the food receiving area, the removable liners sized to overlay the entirety of the food receiving area.

FIG. 3 is an illustration of an embodiment of a food tray with tabbed liners.

FIG. 4 is an illustration of a representative food tray in use according to an exemplary embodiment.

FIG. 5 is an illustration of the food tray of FIG. 3 with a liner covering food stored in the food storage area.

FIG. 6 is another illustration of the food tray of FIG. 3 with the liner enclosing the food storage area.

FIG. 7 is a flow chart illustrating a method of using the food tray of FIGS. 1-6.

### DETAILED DESCRIPTION

This disclosure presents an apparatus and method for a multi-layer disposable grilling/food tray. In many instances, food preparation requires multiple clean surfaces, and therefore multiple trays or dishes. During the food preparation process, a user must dispose of each tray/dish or wash the tray/dish between food preparation stages. This can be time consuming, wasteful and create an unnecessary hassle or mess for the user. This disclosure resolves this problem by providing a grilling/food tray with multiple layers or liners, which as an example, allows a user to prepare raw meat in the tray, cook the meat, and replace the meat in the same tray for resting, serving, and/or storing, thus reducing the hassle, mess, and waste associated with existing food preparation trays.

In the description which follows, like parts are marked throughout the specification and drawings with the same reference numerals, respectively. The drawings are not necessarily to scale and certain features may be shown exaggerated in scale or in somewhat schematic form in the interest of clarity and conciseness.

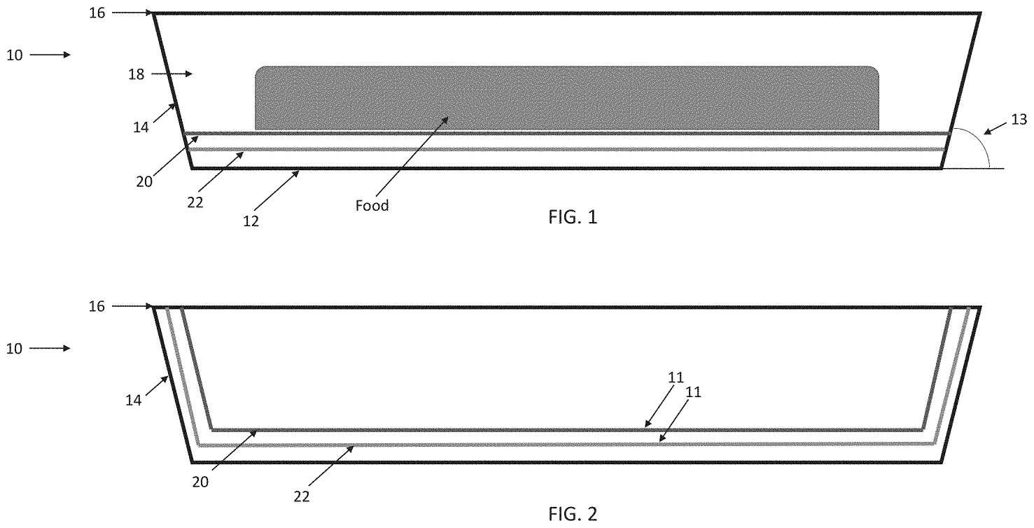

FIG. 1 illustrates a multi-layer food tray 10 in which one or more removable liners 11 are employed to advantage. In the embodiment illustrated in FIG. 1, the food tray 10 includes a bottom wall 12 and a perimeter sidewall 14 forming an opening 16 to enable access to a food receiving and/or storage area 18. As discussed in greater detail below, food, such as meat or vegetables, are placed within the food receiving area 18 for preparation, cooking, serving, and/or storage.

In the embodiment illustrated in FIG. 1, the sidewall 14 is angularly disposed with respect to the bottom wall 12 at an angle 13 to facilitate stacking of multiple trays 10. It should be understood, however, that angle 13 may be greater or less than the actual angle 13 illustrated in FIG. 1 and furthermore, it should be understood that the shape of sidewall 14 may be, in addition to being straight, curved or any combination thereof. In some embodiments, the angle 13 may be approximately 90 degrees so as to be vertically disposed with respect to the bottom wall 12 (when nesting and/or stacking is not desired). According to some embodiments, the tray 10 is generally rectangular, although it should be understood that the shape may vary (i.e., square, oval, circular, semi-circular, etc.). In one or more embodiments, food tray 10 is formed from aluminum; however, it should be understood that any material can be used. For example, in some embodiments, the food tray can be formed of a glass, a ceramic, a plastic, or other suitable material, or any combination thereof.

In the embodiment illustrated in FIG. 1, the food tray 10 contains two liners 11, a first liner 20 and a second liner 22. In FIG. 1, the first liner 20 is positioned as a top layer of the food tray 10 and otherwise exposed to the food storage area 18. The second liner 22 is disposed between the bottom wall 12 and the first liner 20. In the embodiment illustrated in FIG. 1, the first and second liners 20 and 22 extend along and overlay the entire surface of the bottom wall 12. In other embodiments, such as that shown in FIG. 2, the first and second liners 20 and 22 may continue to extend upward from and otherwise cover/overlay all or a portion of the sidewall 14. In yet other embodiments, the first and second liners 20 and 22 extend to overlay only a portion of the bottom wall 12 and/or a portion of the sidewall 14. For example, in one embodiment, the liners 20 and/or 22 may extend to overlay the entirety of the bottom wall 12 and extend upward approximately half of the height of the sidewall 14. In other embodiments, the first liner 20 may extend upward from the base 12 the entire height of the sidewall 14 up to the opening 16, and the second liner 22 may only overlay bottom wall 12. In yet other embodiments, the second liner 22 may overlay the entire bottom wall 12 and cover the entirety of the sidewall 14, and the first liner 20 may only overlay the bottom wall 12.

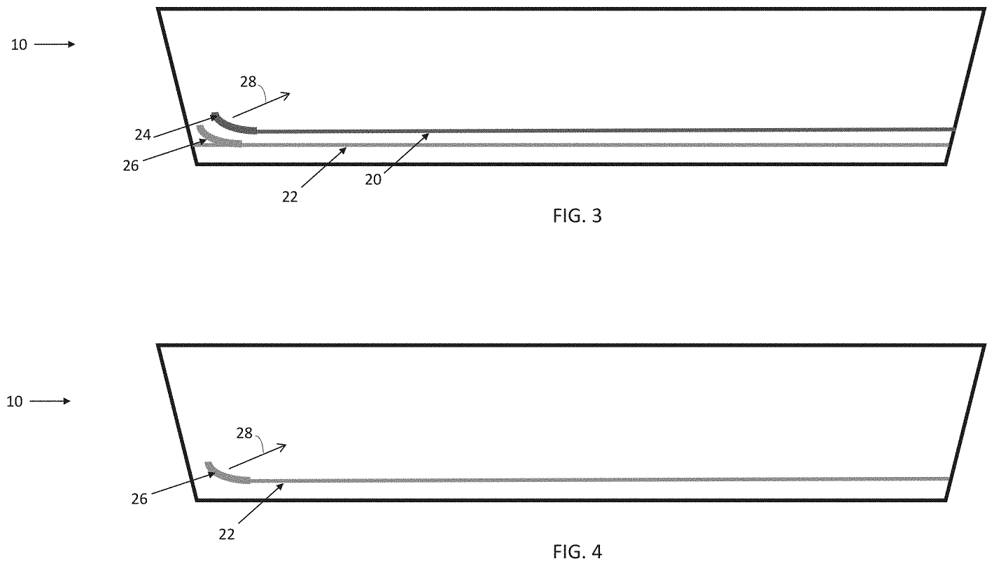

In the embodiment illustrated in FIG. 3, the first and second liners 20 and 22 optionally include respective tabs 24 and 26. According to some embodiments, the first and second tabs 24 and 26 are attached to or are otherwise formed integrally as part of the first and second liners 20 and 22 and at the ends thereof. Alternatively, the first and second tabs 24 and 26 may be attached to or formed on a different side or position on the liners 11, such as for example, being centrally disposed thereon. In some embodiments, the first and second tabs 24 and 26 are color coded in order to distinguish between layers. For example, the first tab 24 may be red. The red color identifies the first liner 20 as the top liner on which the first is first prepared. The red color can help the user distinguish the first liner 20 as the dirty layer after it has been used (e.g., been in contact with raw meat or other contaminated food), and the layer that must be removed before proceeding. Further, for example, the second tab 26 may be green. The green color identifies the second liner 22 as the bottom liner that has not yet been used. The green color can help the user distinguish the second liner 22 as the clean layer that is acceptable and safe to be put in contact with the cooked food. Alternatively, the first and second tabs 24 and 26 may be other distinguishable colors. Additionally and/or alternatively, the first and second tabs 24 and 26 may be labeled with words, symbols, and/or be numbered in order to distinguish between respective layers. According to some embodiments, the tabs 24 and/or 26 may be removable via score lines or perforations, etc. In use, the first and second tabs 24 and 26, in addition to operating as identifiers, may be use and/or otherwise designed as gripping portions in order to aid in the removal of the first and second liners 20 and 22. For example, the first and second liners 20 and 22 may be removed by peeling back (e.g., via the tab) in the direction of arrow 28 and lifting upward from the food tray receiving area 18, as illustrated, for example, in FIG. 3.

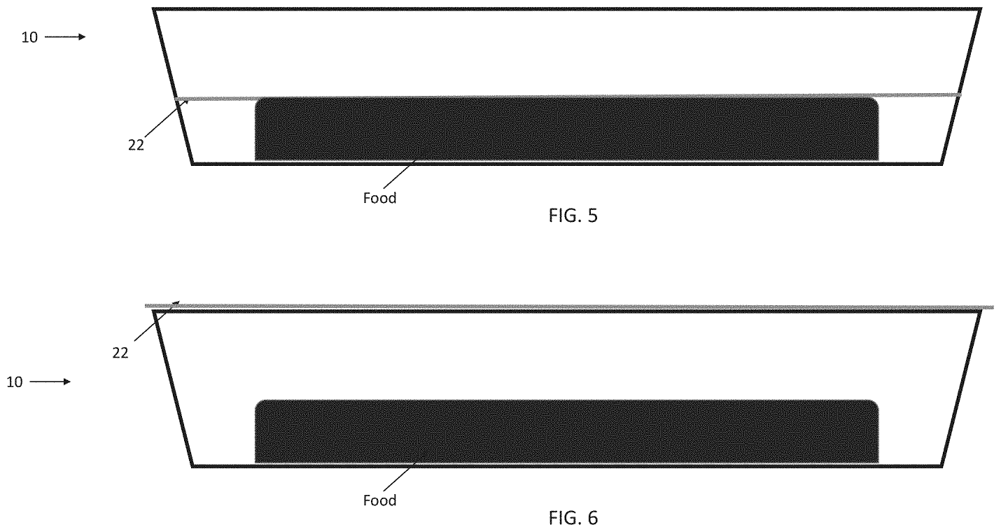

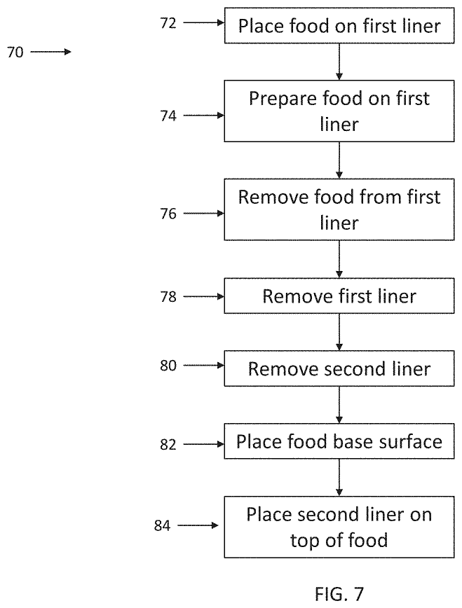

With specific reference to the food tray 10 illustrated in FIGS. 3-6 and the block diagram provided in FIG. 7, a method 70 of using the food tray 10 is provided. At step 72, the food is placed in the food receiving area 18 and onto the exposed liner 20. With the food placed on the liner 20, the food is prepared as desired at step 74. For example, the food may be seasoned, marinated, chopped, etc. prior to grilling or cooking. At step 76, the food is removed from the food receiving area 18 of the food tray 10 and placed on a cooking surface, such as, for example, a grill, oven, stove top, or other applicable cooking surface. The liner 20 is then removed from the food tray 10 at step 78 and as best illustrated in FIGS. 3 and 4. As described above, the first liner 20 may be peeled, lifted, cut, or otherwise removed from the food tray 10 via the tab 24 or otherwise (if present on the liner 20). For example, the tab 24 may be red, indicating to the user to “stop” and remove the first liner 20 before proceeding. After removal, the liner 20 may be disposed of, cleaned and/or reinserted for later use. At step 80, the second liner 22 may be peeled, lifted, cut, or otherwise removed via the tab 26 (if present on the liner 22) and as best illustrated in FIG. 4. For example, the tab 26 may be green, indicating to the user to “go” and use the second liner 22 to proceed. At step 82, the cooked food is returned into food receiving area 18 onto the exposed bottom wall 12, which has remained untouched by the food during the preparation stages. Because the liner 22 was untouched by the food, the liner 22 may be used as a clean lid; accordingly, at step 84, the liner 22 is placed on top of the food for storage thereof, as best illustrated in FIG. 5. Alternatively, the liner 22 may be placed on top of the food tray 10 to seal the opening 16 as illustrated specifically in FIG. 6. Optionally and prior to removing the second liner 22 at step 80, the second liner 22 may function as a second preparation surface, as illustrated in FIG. 4. Regardless, the food tray 10 may be used to serve, store, refrigerate, and/or reheat the food.

The food tray 10 with liners 11 may be made commercially available as a set. The set may be designed in multiple sizes without altering the general configuration described herein. Further, the set may sold in packs of one of more food trays 10 and stacked on top of each other.

According to some embodiments, the first and second liners 20 and 22 may be aluminum sheets. However, the first and second liners 20 and 22 may be otherwise formed such as, for example, a molded sheet, plastic wrap, parchment paper, or any other suitable material. Further, food tray 10 may include more than two liners 11 or in other embodiments, only include a single liner 11. Although embodiments of the food tray 10 have been described in detail, those skilled in the art will also recognize that various substitutions and modifications may be made without departing from the scope and spirit of the appended claims.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes some embodiments of the disclosure, and alterations, modifications, additions and/or changes can be made thereto without departing from the scope and spirit of the disclosed embodiments, the embodiments being illustrative and not restrictive.

Furthermore, the disclosure is not to be limited to the illustrated implementations, but to the contrary, is intended to cover various modifications and equivalent arrangements included within the spirit and scope of the disclosure. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment

What is claimed is:

1. A food tray comprising:
a bottom wall;
a sidewall extending from the bottom wall, wherein the bottom wall and the sidewall form a food storage area;
a first liner overlaying at least a portion of the food storage area;
a second liner disposed between the first liner and at least a portion of the bottom wall, the second liner covering at least a portion of the food storage area;
the first liner having a tab with an identifier thereon and the second liner have a tab with an identifier thereon different from the identifier of the first liner.

2. The food tray of claim 1, wherein the first and second liners correspond to the shape of the food tray.

3. The food tray of claim 1, wherein the identifiers of the first and second liners are colors.

4. The food tray of claim 1, wherein the identifiers of the first and second liners are symbols.

5. The food tray of claim 1, wherein the bottom wall is rectangular.

6. The food tray of claim 1, wherein the first liner overlays the bottom wall and the sidewall.

7. The food tray of claim 6, wherein the second liner overlays the entire bottom wall.

8. The food tray of claim 1, wherein the sidewall forms an opening to facilitate access to the food storage area, wherein the second liner is sized to enclose the opening to the food storage area.

9. The food tray of claim 1, wherein the tabs are sized and positioned to facilitate the removal of the first and second liners.

10. A method of using a food tray, the method comprising:
placing food on a first liner disposed within a food storage area of the food tray;
preparing the food as desired while the food is on the first liner;
removing the food from the food tray;
removing the first liner from the food storage area, wherein removing the first liner exposes a second liner in the food storage area;
removing the second liner from the food storage area to expose a bottom wall of the food storage area;
returning the to the receiving area and resting it on the bottom wall; and
placing the second liner on top of the food.

11. The method of claim 10, further comprising disposing the first and second liners in a waste receptacle after use.

12. The method of claim 11, further comprising disposing the food tray in a waste receptacle after use.

13. The method of claim 10, further comprising reheating the food while in the food tray after placing the second liner on top of the cooked food.

14. The method of claim 10, further comprising placing the food or additional food on the second liner prior to removing the second liner from the food tray.

15. The method of claim 12, further comprising differentiating between the first and second tabs based on color coding.
